(19) United States
(12) Patent Application Publication
(10) Pub. No.: US 2003/0105970 A1
(43) Pub. Date: Jun. 5, 2003

(54) Systems and methods for enforcing single computer use of software

(76) Inventor: Phillip Yuan Pei Jen, Cornelius, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/997,897

(22) Filed: Nov. 30, 2001

(51) Int. Cl. G06F 11/30

(52) U.S. Cl. 713/200

(57) ABSTRACT

The systems and associated methods of the present invention provide copying and use protection while maintaining flexibility for an authorized end user. The present invention is a system and associated method for preventing copying of an optical disc, using an encrypted stored code associated with a computer, a smart card, and a programmable device located on the optical disc, wherein each component contains a unique identification number (ID), and wherein the access-control system compares the IDs of each component, and upon verification that the IDs are identical, allows information on the optical disc to be accessed.

### FIELD OF THE INVENTION

The present invention relates in general to the protecting of software from unauthorized copying. More particularly, the present invention relates to systems and associated methods for preventing the unauthorized installation and copying of software resident on a medium by utilizing a code associated with a computer, a smart card, and a remote programmable device located on the medium.

### BACKGROUND OF THE INVENTION

CD-ROM technology is one of the fastest growing and most cost effective methods to distribute large amounts of information. This technique can be used to distribute information in a variety of formats for diverse applications including music, games, movies, databases, or software. One of the largest problems faced by distributors using CD-ROM technology is pirating or illegal copying of software, music, and video. This theft is costing the distributors, and ultimately the end user's, billions of dollars every year. To maintain the strong popularity and extensive commercialization of CD-ROM technology, an effective means for protecting against the unauthorized copying and use of this information that is not cumbersome for authorized users is required.

Currently, several measures exist to protect CD-ROMs against pirates, however, these systems often prevent or make authorized use much more difficult; for instance, when an authorized user needs to reinstall software after a hard drive failure. Examples of these existing systems include systems that require the use of a key card or smart card that corresponds to the protected software to run and/or install protected software. For example, U.S. Pat. No. 5,033,084 (the '084 patent) to Beecher discloses a computer having random access memory powered by a battery for storing a code that must match the code stored within the software to enable operation of the software. Another example is U.S. Pat. No. 5,590,192 to Lovett et al. that discloses the use of a “smart disk”, that may contain many codes, wherein the smart disk code must match the code associated with the software to allow for installation of the software.

Other systems require a code associated with a particular computer (hardware code) to match a code that has been associated with a protected program before allowing program operation. For example, the '084 patent discloses the past practices of transferring a hardware identifier to a software program upon installation and then only allowing operation of the software program when the identifiers match.

Some systems use a radio transponder in protecting against illegal copying of software. For example, U.S. Pat. No. 5,905,798 to Nerlikar et al. discloses using a radio transponder located on a digital video disk (DVD) for protection. Upon attempting to play the DVD, a DVD player interrogates the radio transponder of the DVD which provides a disc memory location and a code word to the DVD player. The DVD player then reads the memory location on the DVD for a code and allows operation only if the codes match.

Unfortunately, these existing systems do not provide the fullest protection while maintaining flexibility for the authorized user. If a protection system is too burdensome on an authorized user, then the user will reject the underlying CD-ROM technology. For example, in the event that the hard drive of the computer crashes or otherwise fails, it is difficult, if not impossible, to reload at least some of the software protected by these conventional techniques. Accordingly, a need exists for copying and use protection systems and methods that provide adequate protection while maintaining an ease of use for an end user.

### SUMMARY OF THE INVENTION

The systems and associated methods of the present invention provide copying and use protection while maintaining flexibility for an authorized end user. In this regard, the system and associated method of the present invention prevent copying of an optical disc utilizing a code associated with the computer, a smart card, and a programmable RF (radio frequency) device located on the optical disc, wherein each component contains a unique identification number (ID), and wherein the access-control operating system compares the IDs of each component, and upon verification that the IDs are identical, allows information on the optical disc to be accessed.

The present invention enforces “single computer use” of an optical disc and prevents the illegal copying (installation) of the software (e.g., computer programs, music, video games, movies etc.) resident on the disc. The present invention performs these functions by utilizing three basic components: an access-control code associated with a computer, a smart card and an optical disc having a radio frequency device located thereon. After the software resident on the optical disc is first installed, all three components contain the same unique access-control code (an ID number) for that software. This code may be encrypted so that the code may not be copied by other devices.

When a user attempts to use previously installed software that is protected according to the present invention, the access-control operating system compares the code associated with the computer and the code on the smart card and only allows access if the codes are the same.

An important aspect of this invention allows for the reinstalling of the protected software for such instances as hard drive crashes or computer upgrades. Upon reinstalling (i.e., the RF device of the optical disc is already coded) the protected software, the access-control operating system will recognize that the code on the smart card and the code on the RF device are the same and that this code is not resident on the computer and allow installation. During the reinstallation process, the access-control system will write the code common to the RF device and the smart card to the computer's hard drive (memory device). Accordingly, new software does not need to be purchased or new codes need not be obtained whenever a legitimate need to reinstall the software exists. Thus, an authorized user is provided with ease of use while the distributor is still protected from copyists.

### BRIEF DESCRIPTION OF THE DRAWINGS

Having thus described the invention in general terms, reference will now be made to the accompanying drawings, which are not necessarily drawn to scale, and wherein:

FIG. 1 illustrates a system for protecting against the unauthorized use and unauthorized installation of software in accordance with an embodiment of the present invention;

FIG. 2 illustrates an optical disc having a radio frequency device located thereon in accordance with an embodiment of the present invention;

FIG. 3 illustrates the steps for the first time installation of a protected program resident on an optical disc onto a computer having an access-control operating system in accordance with one embodiment of the present invention;

FIG. 4 illustrates the steps for the reinstallation of a protected program resident on an optical disc onto a computer having an access-control operating system in accordance with one embodiment of the present invention; and

FIG. 5 illustrates the steps for preventing the unauthorized use of protected software in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, an index, terms, index categories, domains, data, objects, images, files or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as providing, arranging, searching, transmitting, receiving, prompting, determining, identifying, storing, selecting, deleting, etc. which are often associated with manual operations performed by a human operator. The operations described herein are machine operations performed in conjunction with various input provided by a human operator or user that interacts with the computer or a device connected to the computer.

In addition, it should be understood that the programs, processes, methods, etc. described herein are not related or limited to any particular computer (standalone or distributed) or apparatus, nor are they related or limited to any particular communication architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hardwired logic or programs stored in nonvolatile memory, such as read only memory.

Further, for the following discussion, examples of protected information are often referred to as software or programs. The present invention, of course, may also be used to protect information in a wide variety of formats such as from video, music, games, or any other information resident on many varied mediums including an optical disc.

An embodiment of the present invention uses an access-control operating system that interacts with the standard operating system to allow only authorized use of a protected program (a software program that is distributed using the access-control features of the present invention) or authorized installation of the protected program from an optical disc such as a CD-ROM. This access-control operating system may be crafted as an integral part of any operating system for devices such as computers or may be crafted as an integral part of other devices for video game stations, DVD players or other devices requiring a memory storage device (e.g., CD-ROM etc.). When the user turns on the computer (DVD, video game system, etc.), the operating system (Windows® operating system, etc.) will initiate all essential programs including the access-control operating system. Therefore, the access-control operating system will initiate as soon as the overall operating system is booted. The access-control operating system may function as an integral part of the operating system and would continue detecting and examining the codes resident within the hard drive (memory device of the computer), smart card, and the RF device resident on the optical disc or other memory storage device.

The smart card device/reader may be made mobile or immobile depending upon the requirements of the manufacturers. The ease of removal of the smart card and associated reader from the computer (the DVD player, video game player, etc.) will affect the security of the system; if the smart card device is made physically difficult to remove the security will be greater. Additionally, a smart card often has enough memory to store thousands of codes. Therefore, one smart card is all the typical computer user needs to store all the codes from all programs installed on the computer's hard drive.

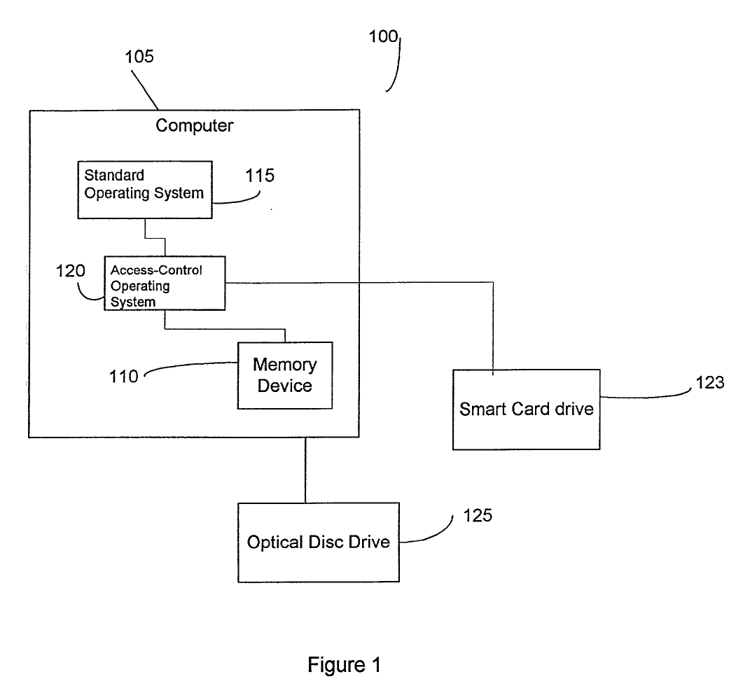

Referring now to FIG. 1, a system for protecting against the unauthorized use or unauthorized installation of software is illustrated. An example system 100 includes a computer 105, a memory device 110 typically a hard drive, a standard operating system 115, an access-control operating system 120, a smart card drive 123 which is communicatively connected to the computer 105, and an optical disc drive 125 which is also communicatively connected to the computer 105. The computer 105 executes the access-control operating system which interacts with the standard operating system 115 to perform the steps necessary to prevent unauthorized use and installation of protected information. When software employing the access-control operating system 120 is installed on the computer 105, an access-control code for that piece of software is stored on the memory device 110 by the computer 105 and the smart card using the smart card drive 123. When a CD-ROM containing protected information is inserted into the optical disk drive 125, the optical disk drive 125 is capable of reading or writing an access-control code to the radio frequency device located on the CD-ROM depending upon whether an ID code has previously been stored in the RF device. The computer 105 is also communicatively connected to the memory device 110 and the smart card drive 123 so that the access-control code may be obtained to compare when a user attempts to execute a protected program in accordance with an embodiment of the present invention.

When a software application employing the access-control operating system 120 is first installed, the system generates an unique access-control code that is written to the hard drive (memory device 110) of the computer 105 and the smart card. The access-control operating system 120 may also be made an integrated part of the standard operating system 115 for the computer 105 so that it would be installed when the standard operating system 115 for the computer 105 is installed. The access-control code that is written to the computer 105 and smart card may be encrypted (such as by using a RSA key) so that other devices may not read it. As known to those skilled in the art, a smart card is a computer component usually readily (not always however) removable by a user (e.g., the smart card may be removably inserted into the computer in similar fashion to a 3½″ diskette). A smart card may take any form that may store a code, such as the AT45DB041 smart card and its family of products distributed by Atmel Corporation of San Jose, Calif.

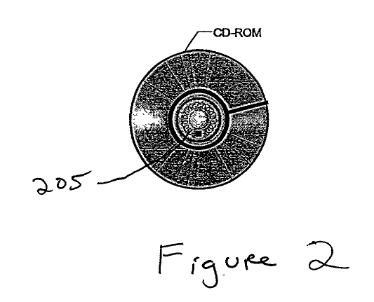

When a protected program resident on an optical disc is first installed on any computer, the programmable device, such as the radio frequency (RF) device, associated with the optical disc is still blank. The access-control operating system generates and then writes a common access-control code to the hard drive of the computer and to the smart card and to the radio frequency device of the optical disk, however, so that the optical disc is thereafter associated with that computer and smart card. The RF device contains a “write-once” memory which cannot be erased or altered once the code is written thereto. FIG. 2 illustrates an optical disc having a radio frequency device located thereon in accordance with an embodiment of the present invention. As shown in FIG. 2, for example, the RF chip 205 may be centrally located and may extend about the hub of the disc.

By associating the particular disc with the computer and the smart card, the access-control operating system may allow the reinstallation of the protected program as long as the user has the disc and the associated smart card without losing protection against software pirates. The information on the CD-ROM cannot be installed on a different computer without both of these components.

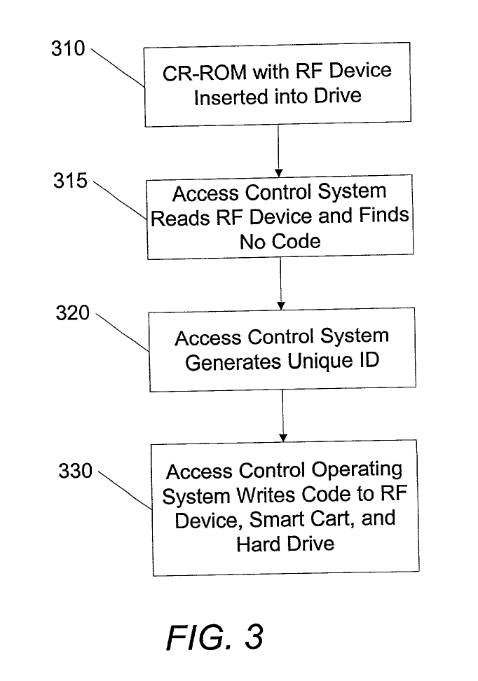

Referring now to FIG. 3, the steps for the first time installation of a protected program resident on an optical disc onto a computer having an access-control operating system in accordance with one embodiment of the present invention is illustrated. In Block 310, a CD-ROM having an RF device is inserted into the CD-ROM drive which is communicatively connected to the computer. The access-control operating system then recognizes that a CD-ROM is in the CD-ROM drive as illustrated by Block 315 and reads the access-control code from the CD-ROM; it is blank for the first time installation. The access-control operating system then generates an unique access-control code to be associated with the application resident on the CD-ROM as illustrated by Block 320. Alternatively, the access-control operating system could simply read an access-control code from the computer's hard drive and the smart card to also assign to the CD-ROM so that the application would be associated with that computer and smart card. The access-control operating system then writes the code to the RF device using the RF drive, writes the code to the smart card using the smart card reader/writer and writes the code to the memory device of the computer as shown in Block 330. Thus, the CD-ROM is programmed with the ID code to prevent subsequent loading of the software on another computer.

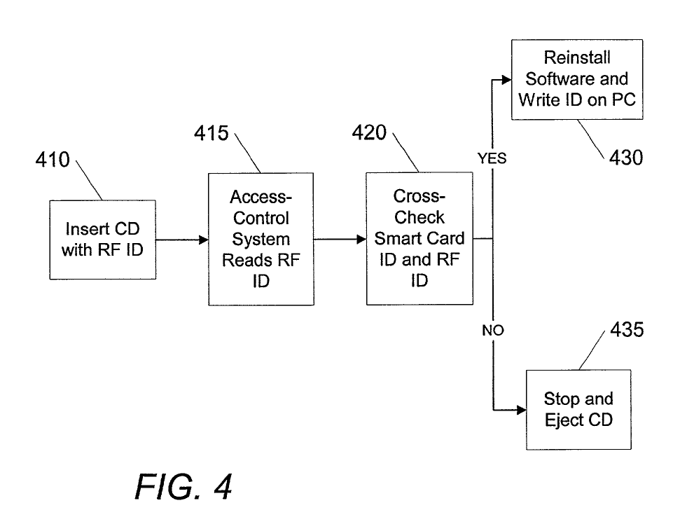

Referring now to FIG. 4, the steps for the reinstallation of a protected program resident on an optical disc onto a computer having an access-control operating system in accordance with one embodiment of the present invention is illustrated. In Block 410, a CD-ROM having a RF device that has had an access-control code written thereon is inserted into the CD-ROM drive which is communicatively connected to the computer. The access-control operating system then recognizes that a CD-ROM is in the CD-ROM drive as illustrated by Block 415 and reads the RF code from the RF device using the RF drive. The access-control operating system then reads the access-control code from the smart card and compares the RF code and the smart card code as illustrated by Block 420. If the codes are the same, the access-control operating system then writes the common code to the computer—thus overwriting the previous access-control code associated with the computer/application that would have been generated if the access-control operating system was re-installed after a hard drive failure, etc.—and allows the user to reinstall the protected program as shown in Block 430. If the codes do not match, then the access-control operating system ejects the CD-ROM and does not allow the software to be re-installed as illustrated in Block 435. With all 3 IDs matching after writing the common code to the computer, the optical disc installation process can access the information stored on the optical disc. If attempts to install software from this optical disc on different computers are made, the access-control operating system will detect that the optical disc has a different ID code than the smart card, and the access-control operating system will prevent the installation of the program on the optical disc.

Since the system and method of the present invention include a technique for reinstalling the protected software that is not overly burdensome for the end user, the use of the system and method of the present inventor should be facilitated since the end users need not purchase additional copies of the software or otherwise perform complicated and time-consuming reinstallation procedures. However, the system and method of the present invention does ensure that an authorized end user is reinstalling the copy of the software assigned to them by requiring that the ID codes for the smart card and the RF device of the CD-ROM match before permitting reinstallation.

Each time that a user wants to run the installed software, the access-control operating system checks the ID code of the smart card (via a smart card reader) and the ID code stored on the computer. If the codes match, then the access-control operating system allows the installed protected program to run. However, if the ID code stored on the smart card and the ID code stored on the computer do not match, then the access-control operating system will prevent the installed software program from running. The uniform ID guarantees the use of the software only on a single machine because each computer will have a unique ID code. In addition, the uniform ID ensures that it is the authorized end user that is attempting to run the software by comparing the ID code on the smart card to the ID code of the computer.

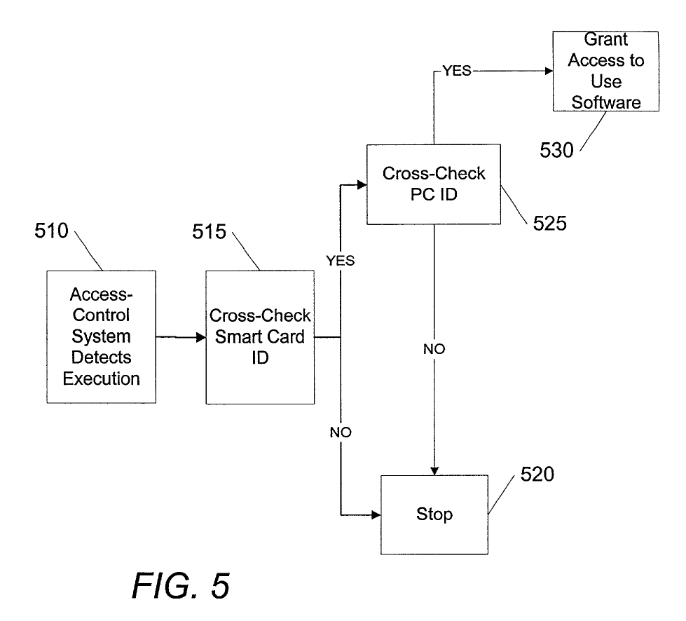

Referring now to FIG. 5, the steps taken by the access-control operating system each time the loaded protected software launches are illustrated and explained hereinafter in more detail. The access-control operating system first recognizes that a user is attempting to execute an installed protected program as illustrated by Block 510. The access-control operating system then checks that a smart card is resident in the smart card drive and checks the ID code for that protected program on the computer (hard drive) as shown in Block 515. If no smart card is present then the access-control operating system does not allow the protected software to be used as shown in Block 520. If a smart card is present, however, the access-control operating system reads the code(s) from the smart card and then the access-control operating system compares this code(s) with the code resident on the computer for the protected program as shown in Block 525. If a matching code is found on the smart card, then the access-control operating system allows the program to execute or grants the user access to the information as shown in Block 530. If no matching code is found, then the access-control operating system stops the execution of the protected program as shown in 520.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for protecting against the unauthorized use of software originally installed upon a computer from a medium having a radio frequency device, comprising:
obtaining a first access-control code from a memory device resident within the computer, wherein the access control code is associated with the computer, a smart card, and the radio frequency device;
obtaining a second access-control code resident on the smart card, wherein the access control code is associated with the computer, the smart card, and the radio frequency device; and
allowing software to execute when the first access-control code and the second access-control code are the same.

2. The method of claim 1, further comprising installing the software on the computer.

3. The method of claim 2, wherein installing the software on the computer comprises obtaining the first access-control code, obtaining the second access-control code, comparing the first and the second access-control codes, and if the first and second access control codes are the same, writing the access control code to the radio frequency device associated with the medium.

4. The method of claim 2, wherein installing the software on the computer comprises obtaining the first access control code, obtaining the second access control code, comparing the first and second access control codes, and, if the first and second access control codes are identical, writing the access control code to the medium that embodies the software.

5. A method for protecting against the unauthorized installation of software resident on a medium, comprising:
obtaining a first access-control code from a memory device resident within a computer;
obtaining a second access-control code resident on a smart card;
obtaining any third access-control code associated with the medium;
comparing the first access-control code and the second access-control code; and
allowing installation of the software when the first access-control code and the second access-control code are the same and the medium is without any third access-control code.

6. The method of claim 5, wherein installing the software comprises writing the first access-control code to a programmable device associated with the medium when the first access-control code and the second access-control code are the same and the medium is otherwise without any third access-control code.

7. The method of claim 5, further comprising allowing installation of the software when the third access-control code and the second access-control code are the same.

8. The method of claim 7, further comprising writing the first access-control code to the memory device resident on the computer when the second access-control code and the third access-control code are the same.

9. A method for allowing a user to reinstall onto a computer protected software resident on a medium, comprising:
obtaining a first access-control code resident on a smart card;
obtaining a second access-control code associated with the medium;
comparing the first access-control code and second access-control code; and
installing the protected software on the computer if the first access-control code and second access-control code are the same.

10. The method of claim 9, further comprising writing the first access-control code to a memory device of the computer.

11. The method of claim 9, further comprising ejecting the medium if the first access-control code and second access-control code are not the same

12. A system for protecting against the unauthorized use and unauthorized installation of software, comprising:
a computer having a memory device;
a smart card drive communicatively connected to the computer, wherein said smart card includes an access-control code that is capable of being read by said computer from the smart card; and
an optical disc drive communicatively connected to the computer for receiving an optical disc having a radio frequency device embodied therein, said optical disc drive comprising a radio frequency drive capable of reading an access-control code from the radio frequency device.

13. The system of claim 12, wherein the radio frequency drive is also capable of writing an access-control code to the radio frequency device.

14. A computer-readable storage medium encoded with processing instructions for implementing a method for protecting against the unauthorized installation of software, said processing instructions directing a computer to perform the steps of:
obtaining a first access-control code from a memory device resident within a computer;
obtaining a second access-control code resident on a smart card;
obtaining any third access-control code resident on a programmable device that is associated with the medium;
comparing the first access-control code, the second access-control code, and the third access-control code; and
allowing installation of the software when the first access-control code and the second access-control code are the same and the programmable device associated with the medium is without any third access-control code.

15. The computer-readable storage medium of claim 14 further comprising processing instructions directing a computer to perform the step of writing the first access-control code to the programmable device associated with the medium when the first access-control code and the second access-control code are the same and the medium is otherwise without any third access-control code.

16. A computer-readable storage medium encoded with processing instructions for implementing a method for protecting against the unauthorized installation of software, said processing instructions directing a computer to perform the steps of:
obtaining a first access-control code from a memory device resident within a computer;
obtaining a second access-control code resident on a smart card;
obtaining any third access-control code resident on a programmable device that is associated with the medium;
comparing the first access-control code, the second access-control code, and the third access-control code; and
allowing installation of the software when the first access-control code and the second access-control code and the third access-control code are the same.

17. A computer-readable storage medium encoded with processing instructions for implementing a method for protecting against the unauthorized use of software originally installed upon a computer from a medium having a radio frequency device, said processing instructions directing a computer to perform the steps of:
obtaining a first access-control code from a memory device resident within the computer, wherein the access control code is associated with the computer, a smart card, and the radio frequency device;
obtaining a second access-control code resident on the smart card, wherein the access control code is associated with the computer, the smart card, and the radio frequency device; and
allowing software to execute when the first access-control code and the second access-control code are the same.

18. The computer-readable storage medium of claim 17 further comprising processing instructions directing a computer to perform the step of installing the software on the computer.

19. The computer-readable storage medium of claim 18 wherein the processing instructions directing a computer to perform the step of installing the software comprises obtaining the first access-control code, obtaining the second access-control code, comparing the first and the second access-control codes, and if the first and second access control codes are the same, writing the access control code to the radio frequency device associated with the medium.
